(19) United States
(12) Patent Application Publication
(10) Pub. No.: US 2009/0217637 A1
(43) Pub. Date: Sep. 3, 2009

(54) METHOD AND APPARATUS FOR SWINGING LINE

(76) Inventor: Harold E. Dunn, Ballwin, MO (US)

Correspondence Address: SENNIGER POWERS LLP, 100 NORTH BROADWAY, 17TH FLOOR, ST LOUIS, MO, 63102, US

(21) Appl. No.: 12/039,334

(22) Filed: Feb. 28, 2008

(51) Int. Cl. A01D 34/416

(52) U.S. Cl. 56/13.6; 56/12.7; 56/10.2 R

(57) ABSTRACT

Apparatus for swinging a flexible line about an imaginary axis. The apparatus includes an elongate body extending along a centerline between a head end at which the imaginary axis is located and a tail end opposite the head end. The apparatus includes a motor mounted remote from the head end of the body having an output and a head rotatably mounted on the head end of the body. The head is operatively connected to the motor output for rotation about the imaginary axis in response to operation of the motor. The head has a curved passage extending from an inlet directed generally along the imaginary axis into which the flexible line is feedable to an outlet directed generally lateral to the imaginary axis through which the line is extendable. The passage is sized for passing the line from the inlet to the outlet.

### BACKGROUND

The present invention is directed to methods and apparatus for swinging line.

Apparatus for swinging line are common. For example, one such apparatus swings line, such as a nylon monofilament, about an imaginary axis to cut weeds, grass and other light vegetation. Most conventional apparatus for swinging line to cut vegetation include a head having a spool of line that is selectively dispensed so it extends some predetermined distance from the head. The apparatus also includes a motor for rotating the spool to swing the line about the imaginary central axis of the spool. The line swings with the head at a speed sufficient to cut the vegetation. When the line breaks or frays, the user bumps the head on the ground to disengage a clutch in the head to release more line from the head. Among the problems associated with this type of system is that bumping the apparatus causes unnecessary wear and tear on the apparatus and the user.

Although these apparatus work fairly well, the line tends to become tangled on the spool inside the head when the user bumps the head on the ground to disengage the clutch. Once the line is tangled, no more line can be dispensed when a need arises. When the line becomes tangled, the head must be disassembled to remove the spool, and the line must be cut or untangled. Then, the spool must be rewound and the head must be reassembled so additional line can be dispensed. The head must also be disassembled each time the supply of line runs out. If the apparatus is used for an extended period of time, the user may have to stop and reload the apparatus several times. This process takes time away from the task at hand, limiting the efficiency of the apparatus and causing frustration for the user. Many prior attempts to solve this problem have met with limited success.

Another issue that occurs with these apparatus is that users frequently cannot determine the length of line extending from the head. The line may be too short, limiting the effectiveness of the apparatus for cutting. Or the line may be too long. Although the apparatus frequently include a blade that cuts the excess line so the line extending from the head can be cut to an optimal length, cutting excess line unnecessarily wastes line that could otherwise be used, resulting in increased operational cost. Further, if line is let out frequently, many line remnants become scattered about. Because conventional line is not biodegradable, over time remnants may cause environmental concerns.

Conventional apparatus are also cumbersome and uncomfortable to use for extended periods. Although some manufactures provide harnesses for supporting the apparatus to increase comfort, extended use can result in pain centered in joints, tendons and/or muscles. Thus, there is a need for apparatus providing improved ergonomic operation.

### SUMMARY

In one aspect, the present invention includes apparatus for swinging a flexible line about an imaginary axis. The apparatus comprises an elongate body extending along a centerline between a head end at which the imaginary axis is located and a tail end opposite the head end. The apparatus includes a motor mounted remote from the head end of the body having an output. In addition, the apparatus comprises a head rotatably mounted on the head end of the body and operatively connected to the motor output for rotation about the imaginary axis in response to operation of the motor. The head has a curved passage extending from an inlet directed generally along the imaginary axis into which the flexible line is feedable to an outlet directed generally lateral to the imaginary axis through which the line is extendable. The passage is sized for passing the line from the inlet to the outlet.

In another aspect, the present invention includes apparatus for cutting vegetation with a flexible line swinging about an imaginary axis. The apparatus comprises an elongate body extending along a centerline between a head end at which the imaginary axis is positioned and a tail end opposite the head end from which an operator operates the apparatus. In addition, the apparatus includes a motor mounted on the body having an output and a head rotatably mounted on the head end of the body for rotation about the imaginary axis and operatively connected to the motor output for rotating the head about the imaginary axis. The head has a curved passage extending from an inlet directed generally along the imaginary axis to an outlet directed generally lateral to the imaginary axis so the outlet swings along an arc as the head rotates about the imaginary axis. The passage is sized for passing the line from the inlet to the outlet. Further, the apparatus includes a transmission operatively connected between the motor output and the head for rotating the head about the imaginary axis in response to operation of the motor. The apparatus also comprises a housing surrounding the transmission having an opening for passing line through the housing and into the inlet of the passage in the head.

In still another aspect, the present invention includes apparatus for cutting vegetation with a flexible line swinging about an imaginary axis. The apparatus comprises a body and a motor mounted on the body having an output. In addition, the apparatus includes a head rotatably mounted on the body and operatively connected to the motor output for rotating the head about the imaginary axis in response to operation of the motor. The head has a curved passage extending from an inlet directed generally along the imaginary axis to an outlet directed generally lateral to the imaginary axis so the outlet swings along an arc as the head rotates about the imaginary axis. The passage is sized for passing the line from the inlet to the outlet. Moreover, the apparatus includes a light source operatively connectable to the line for directing light to an end of the line extending from the outlet of the head.

In another aspect, the present invention includes apparatus for cutting vegetation with a flexible line swinging about an imaginary axis comprising a body and at least one of a wheel, a track, a leg or a skid attached to the body for contacting ground to support the body above the ground. The apparatus also includes a motor mounted on the body having an output and a head rotatably mounted on the body and operatively connected to the motor output for rotating the head about the imaginary axis in response to operation of the motor. The head has a curved passage extending from an inlet directed generally along the imaginary axis to an outlet directed generally lateral to the imaginary axis so the outlet swings along an arc as the head rotates about the imaginary axis. The passage is sized for passing the line from the inlet to the outlet.

In yet another aspect, the present invention includes apparatus for swinging a flexible line about an imaginary axis comprising a body and a motor mounted on the body having an output. Further, the apparatus comprises a head rotatably mounted on the body and operatively connected to the motor output for rotation about the imaginary axis in response to operation of the motor. The head has a curved passage extending from an inlet directed generally along the imaginary axis into which the flexible line is feedable to an outlet directed generally lateral to the imaginary axis through which the line is extendable. The passage is sized for passing the line from the inlet to the outlet. Still further, the apparatus comprises a transmitter operatively connectable to the line for transmitting information to the line.

In another aspect, the present invention includes apparatus for apparatus for swinging a flexible line about an imaginary axis comprising a body and a motor mounted on the body having an output. The apparatus further comprises a head rotatably mounted on the body and operatively connected to the motor output for rotation about the imaginary axis in response to operation of the motor. The head has a curved passage extending from an inlet directed generally along the imaginary axis into which the flexible line is feedable to an outlet directed generally lateral to the imaginary axis through which the line is extendable. The passage is sized for passing the line from the inlet to the outlet. Further, the apparatus includes a receiver mounted adjacent the line for receiving information transmitted through the line.

In an additional aspect, the present invention includes apparatus for swinging a preselected element about an imaginary axis comprising a body and a motor mounted on the body having an output. Further, the apparatus comprises a head rotatably mounted on the body and operatively connected to the motor output for rotation about the imaginary axis in response to operation of the motor. The head has a curved passage extending from an inlet directed generally along the imaginary axis to an outlet directed generally lateral to the imaginary axis. Still further, the apparatus comprises line extending through the passage from the inlet through the passage to the outlet and extending outward from the outlet to an end. A preselected element is attached to the end of the line. The element is selected from a group of elements consisting of an energy source and a cutter.

In still another aspect, the present invention includes method of transmitting information through a line comprising swinging the line about an imaginary axis, transmitting information to an end of the line, and receiving the transmitted information at an end of the line opposite the end to which the information is transmitted.

In another aspect, the present invention includes a method of opening a passage comprising inserting a line into the passage, and swinging the line about an imaginary axis so an end of the line traveling through an arc opens the passage.

In a further aspect, the present invention includes apparatus for cutting vegetation with a flexible line swinging about an imaginary axis. The apparatus comprises an elongate body extending along a centerline between a head end at which the imaginary axis is positioned and a tail end opposite the head end from which an operator operates the apparatus. Further, the apparatus includes a motor mounted on the body having an output and a head rotatably mounted on the head end of the body for rotation about the imaginary axis and operatively connected to the motor output for rotating the head about the imaginary axis. Still further, the apparatus comprises a grip connected to the body adapted for engaging a hand of a user, and a brace connected to the body adapted for engaging an arm of the user while the grip engages the user's corresponding hand.

In yet another aspect, the present invention includes apparatus for cutting vegetation with a flexible line swinging about an imaginary axis comprising an elongate body extending along a centerline between a head end at which the imaginary axis is positioned and a tail end opposite the head end from which an operator operates the apparatus. The apparatus also comprises a motor mounted on the body having an output and a head rotatably mounted on the head end of the body for rotation about the imaginary axis and operatively connected to the motor output for rotating the head about the imaginary axis. The apparatus includes a grip mounted on the body spaced from the head end. The grip extends from the body along a grip axis extending from a predetermined axial position along the body, at a predetermined tilt angle measured relative to the body, at a predetermined radial position measured from the grip to the centerline, at a predetermined rotational angle measured about the grip axis. At least one of the axial position and the tilt angle are selectively adjustable.

In a further aspect, the present invention includes apparatus for cutting vegetation with a flexible line swinging about an imaginary axis comprising an elongate body extending along a centerline between a head end at which the imaginary axis is positioned and a tail end opposite the head end from which an operator operates the apparatus. The apparatus also comprises a motor mounted on the body having an output and a head rotatably mounted on the head end of the body for rotation about the imaginary axis and operatively connected to the motor output for rotating the head about the imaginary axis. The apparatus includes a grip mounted on the body extending generally upward from the body when the head is positioned for cutting vegetation.

In still another aspect, the present invention includes apparatus for cutting vegetation with a flexible line swinging about an imaginary axis comprising a body and a motor operatively connected to the body having an output. The apparatus also includes a head rotatably mounted on the body for rotation about the imaginary axis and operatively connected to the motor output for rotating the head about the imaginary axis. The apparatus comprises line extending from the head and swinging about the imaginary axis in response to the head rotation. The line comprises an at least partially biodegradable material.

In yet another aspect, the present invention includes apparatus for cutting vegetation with a flexible line swinging about an imaginary axis. The apparatus includes an elongate body extending along a centerline between a head end at which the imaginary axis is positioned and a tail end opposite the head end from which an operator operates the apparatus and a motor mounted on the body having an output. Further, the apparatus comprises a head rotatably mounted on the head end of the body for rotation about the imaginary axis and operatively connected to the motor output for rotating the head about the imaginary axis, and a grip mounted on the body spaced from the head end. The grip extends from the body along a grip axis extending from a predetermined axial position along the body, at a predetermined tilt angle measured relative to the body, at a predetermined radial position measured from the grip to the centerline, at a predetermined rotational angle measured about the grip axis. Further, the apparatus comprises a handle mounted on the body and axially spaced from the grip and the head end. The handle extends from the body along a handle axis extending from a predetermined axial position along the body, at a predetermined tilt angle measured relative to the body, at a predetermined radial position measured from the handle to the centerline, at a predetermined rotational angle measured about the handle axis.

Other aspects of the present invention will be in part apparent and in part pointed out hereinafter.

### BRIEF DESCRIPTION OF DRAWINGS

FIG. 1 is a perspective of apparatus of a first embodiment of the present invention;

FIG. 2 is a fragmentary side elevation in partial section of a tail end of the apparatus;

FIG. 3 is a perspective detail of a portion of the apparatus identified in FIG. 1 showing a housing removed;

FIG. 4 is a fragmentary cross section of a portion of the head end of the apparatus;

FIG. 5 is a schematic side elevation of apparatus of a second embodiment;

FIG. 6 is a schematic top plan of apparatus of a third embodiment;

FIG. 7 is a schematic side elevation of apparatus of a fourth embodiment;

FIG. 8 is a perspective of apparatus of a fifth embodiment;

FIG. 9 is a schematic representation of apparatus a sixth embodiment;

FIG. 10 is a schematic representation of apparatus a seventh embodiment; and

FIG. 11 is a schematic representation of apparatus an eighth embodiment.

Corresponding reference characters indicate corresponding parts throughout the several views of the drawings.

### DETAILED DESCRIPTION

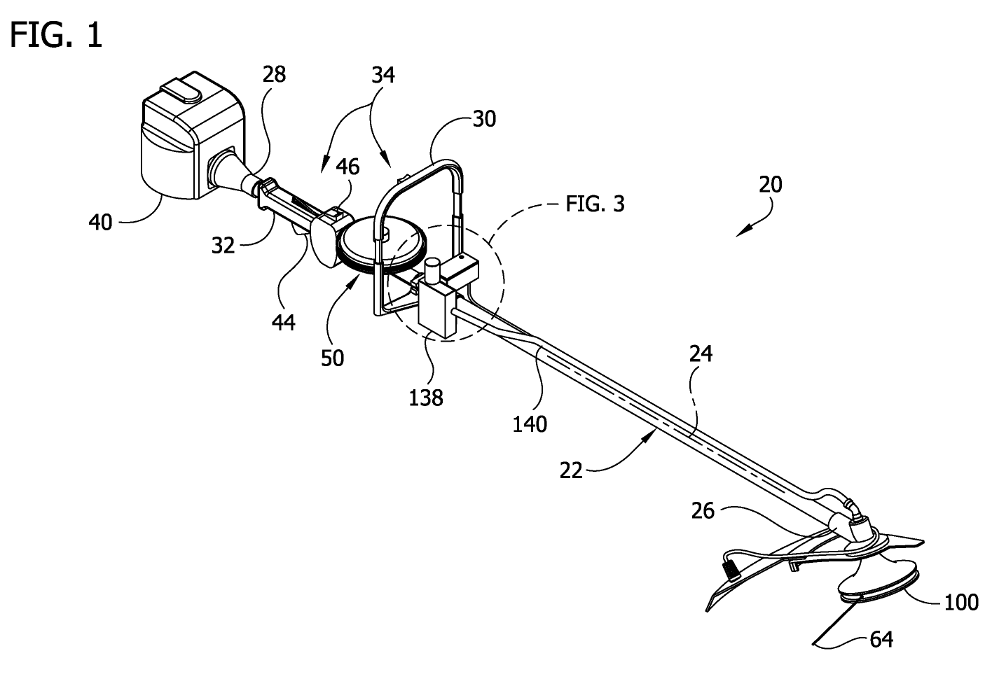

Referring to FIG. 1, apparatus of a first embodiment is designated in its entirety by the reference number 20. The apparatus 20 includes an elongate body, generally designated by 22, extending along an imaginary centerline 24 between a head end 26 and a tail end 28 opposite the head end. A handle 30 and a grip 32 are provided at the tail end 28 of the body 22 for guiding the apparatus 20. In one embodiment, the handle 30 is adjustable (e.g., having telescopic sides as shown) for improving ergonomic adjustability to enhance user comfort during use. Controls, generally designated by 34, are mounted on the body adjacent the tail end 28 for operating the apparatus 20 as will be explained in further detail. A motor 40 is also mounted on the body 22. In one embodiment, the motor 40 is mounted on the body 22 so it is remote from the head end 26. For example, in one embodiment the motor 40 is mounted at the tail end 28 to reduce weight at the head end 26 so the weight of the apparatus 20 is balanced near the handle.

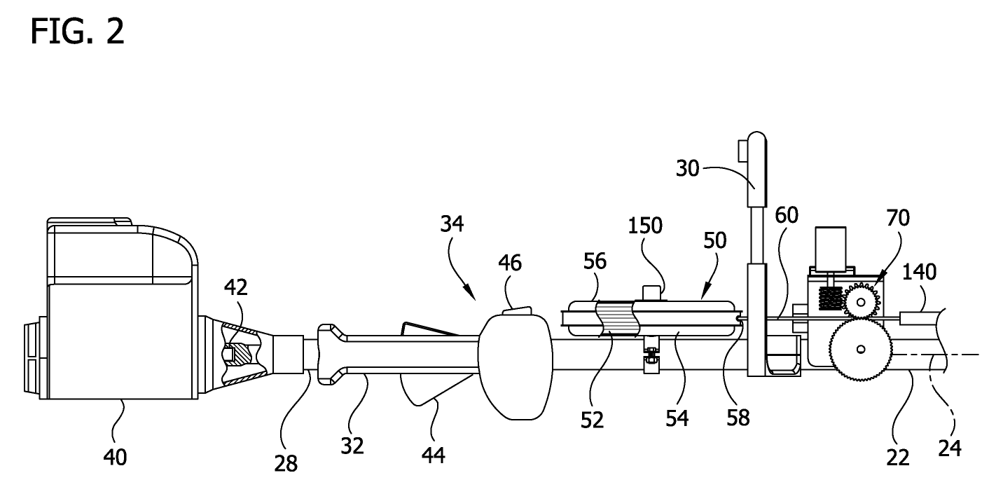

As illustrated in FIG. 2, the motor 40 has an output 42. For example, in the illustrated embodiment the motor 40 has a conventional output shaft that rotates about the centerline 24 of the body 22. Although the motor 40 is illustrated as being a conventional gasoline powered motor, those skilled in the art will appreciate that the motor may be of other types, including an electric motor, a pneumatic motor or a hydraulic motor. The motor 40 is operatively connected to one or more of the controls 34. For example, the motor may be operatively connected to a trigger 44 (FIG. 1) on the grip 32 so the output 42 of the motor 40 speeds up and slows down when the trigger is depressed and released, respectively. The motor 40 may also be operatively connected to a switch 46 for selectively turning the motor off when desired. As other aspects of the motor 40 are conventional or unrelated to central features of the current invention, they will not be described in further detail.

As further illustrated in FIG. 2, a line supply, generally designated by 50, is mounted on the body 22 of the apparatus 20. In one embodiment, the line supply 50 includes a coil 52 rotatably held in a housing 54 mounted on the body 22 near the tail end 28. In one embodiment, at least a portion of the housing 54 is visually transparent so a user can view the coil 52 to determine when the supply is low without opening the housing. The housing 54 includes a cover 56. The cover 56 may be opened to insert fresh coils 52. The housing 54 also includes a port 58 allowing line 60 in the coil 52 to exit the housing. As will be appreciated by those skilled in the art, the supply 50 may have other forms such as line held on a spool or line held in a canister (not shown) without departing from the scope of the present invention. The line 60 extends between a supply end (not shown) and a working end 64 (FIG. 1). In some embodiments, the line 60 is biodegradable to reduce an amount of time residual line lays around. For example, the biodegradable line 60 may be made of cottonoids, cellulosics, polyglycolic acid, polylactic acid, polyhydroxybutyrate, or other suitable biodegradable materials.

As further illustrated in FIG. 2, a line positioning mechanism, generally designated by 70, is mounted on the body 22. The mechanism 70 is operationally positioned between the supply 50 and the head end 26 of the body 20 and is operatively connectable to the line 60 extending out of the port 58 in the housing 54 to selectively position the line as will be explained. The mechanism 70 is operatively connectable to the line 60 to selectively position the working end 64 (FIG. 1) of the line and firmly hold the line in place countering centrifugal force caused by spinning line as will be described below.

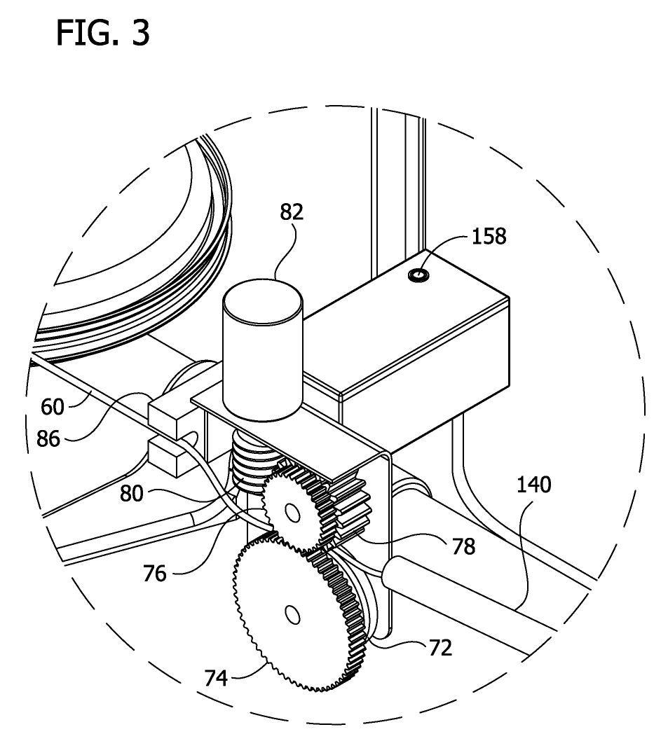

As illustrated in FIG. 3, the mechanism 70 of one embodiment comprises a roller 72 rotatably mounted on the body 22. The roller 72 includes a gear 74 that meshes with another gear 76 so the gears turn in opposite directions. The gear 76 is joined with another gear 78 so they turn together about a common axis. The roller 72 is positioned so the line 60 wraps at least partially around it to ensure the line is gripped securely by the roller. A worm gear 80 driven by an actuator or motor (e.g., electric motor 82) engages the gear 78 to turn the roller 72 to retract or advance the line 60. The controls 34 also include a switch 84 for selectively energizing the motor 82 to rotate the roller 72 in directions suitable for advancing or retracting the line 60. As will be appreciated by those skilled in the art, several different types of actuators or motors may be used to turn the roller 72 without departing from the scope of the present invention. For example, in one embodiment (not shown) it is envisioned the roller 72 may be operatively connected to the motor 40 to selectively drive the roller. In one embodiment, a line sensor 86 is located between the supply 50 and the mechanism 70 for detecting when the supply runs out. The sensor 86 is operatively connected to the motor 82 so that the line 60 cannot be advanced farther after the supply is empty. In one embodiment, the sensor 86 is a biased leaf switch. Alternatively, the sensor 86 may be connected to the motor 40 to stop the output 42 from turning.

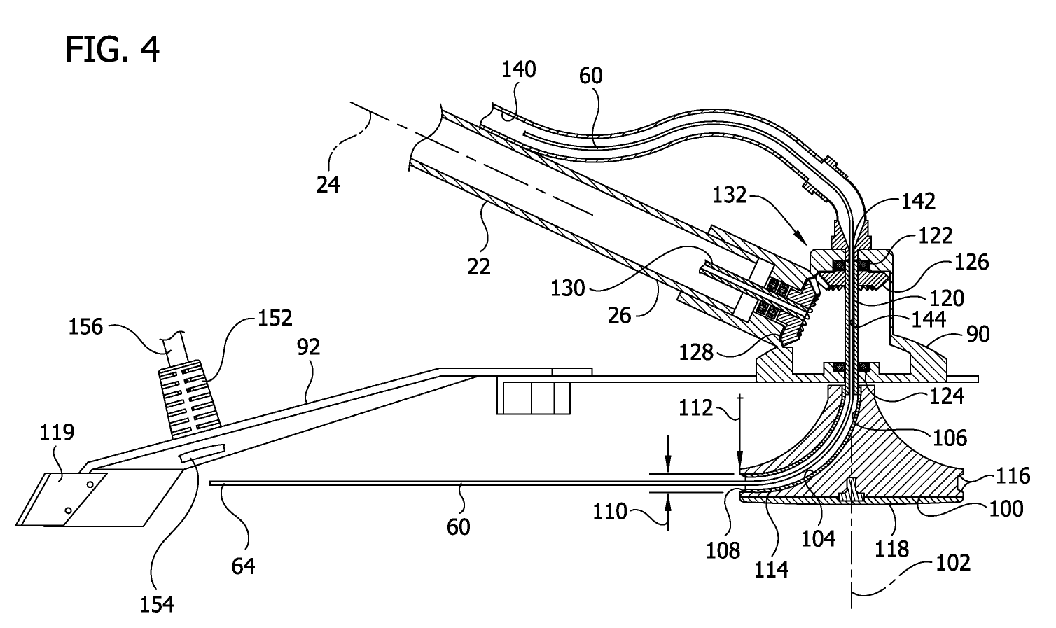

As illustrated in FIG. 4, the head end 26 of the body 22 has a housing 90 and a shroud 92. A head 100 is rotatably connected to the housing 90. The head 100 rotates about an imaginary axis 102 extending generally vertically when the centerline 24 of the body 22 is in its typical nominal operating position. As will be explained in further detail, the head 100 is operatively connected to the motor output 42 (FIG. 2) for rotation about the imaginary axis 102 in response to operation of the motor 40. The head 100 has a curved internal passage 104 extending from an inlet 106 directed generally along the imaginary axis 102 to an outlet 108 directed generally lateral to the imaginary axis. Although the passage 104 may have other sizes and shapes without departing from the scope of the present invention, in one embodiment the passage has a generally circular cross section having a generally uniform diameter 110 from about 6 millimeters (mm) to about 10 mm or more. This diameter permits the line 60 to freely pass through the passage 104. Further, although the passage may have other shapes without departing from the scope of the present invention, in one embodiment the passage 102 curves about a radius 112 from about 2 centimeters (cm) to about 4 cm. Although the head 100 may be formed of other materials and in other ways, in one embodiment the head is molded from an impact resistant polymer such as high density polyethylene or ultra high molecular weight plastic. Tubing 114 is positioned in the head 100 to define the passage 104 so the line 60 does not abrade the head during operation. In one embodiment, the tubing 114 is made from stainless steel, but other materials having corrosion and abrasion resistance and a low coefficient of friction are also contemplated. Further, circumferential guides 116 are positioned above and below the outlet 108 to guide the line 60 so it wraps around the head 100 if it impacts an immoveable object. A sacrificial shield 118 may be attached to the head 100 to protect the head. The shield 118 may be replaced if it becomes worn such as from contacting the ground. A conventional line cutter 119 may be positioned on the shroud 92 for cutting the line 60. As will be appreciated by those skilled in the art, the head 100 may be centrifugally balanced to account for imbalances including those caused by line 60 and tubing 114 weight.

As further shown in FIG. 4, the head 100 is connected to a hollow shaft 120 rotatably mounted in the housing 90. In one embodiment, the shaft 120 is mounted on bearings 122, 124, permitting the shaft to rotate about the imaginary axis 102 of the housing 100. A bevel gear 126 is mounted on the shaft 120. The bevel gear 126 meshes with another bevel gear 128 mounted on a shaft 130 extending generally along the centerline 24 of the body. The shaft 130 is operatively connected to the output 42 (FIG. 2) of the motor 40, so the bevel gears 126, 128 turn in response to the output shaft turning, resulting in the head 100 turning about the imaginary axis 102. As will be appreciated by those skilled in the art, the gears 126, 128 form a transmission, generally designated by 132. Although the bevel gears 126, 128 constitute the transmission 132 of one embodiment, those skilled in the art will appreciate that other conventional transmissions may be used without departing from the scope of the present invention. For example, the transmission may be made from a U-joint, a flexible drive made of resilient material, a larger gear train, or a hydrostatic transmission. In alternative embodiments, it is envisioned that attachments such as brush cutting blades (not shown) may be attached to or may replace the head 100. As these attachments are conventional, they will not be described in further detail.

The line 60 extends from the supply 50 through the line sensor 86 and around the roller 72. In one embodiment, the roller 72 is housed in a housing 138 (FIG. 1) adapted to guide the line 60 around roller and into a tube or passage 140 extending along the body 22 substantially parallel to the centerline 24. Thus, the apparatus 20 can be loaded with line 60 without removing the housing 138. The line 60 emerges from the passage 140 near the head end 26 of the body 20. From this position, the line 60 extends through an opening 142 in the housing 90, through a central opening 144 in the shaft 120, and into the inlet 106 of the passage 104. The line 60 continues through the passage 104 and to the outlet 108. The line 60 extends from the outlet 108 of the passage 104 by a predetermined distance. In some embodiments, the tube 140 is at least partially visually transparent so a user can visually confirm that line 60 is present.

Operating the motor turns the head 100, which swings a portion of the line 60 extending from the head 100 about the imaginary axis 102. In one embodiment, the line 60 swings about the axis 102 at a speed sufficient to cut grass. Although the working end 64 of the line 60 may extend from the imaginary axis 102 by other distances without departing from the scope of the present invention, in one embodiment the working end of the line extends from the imaginary axis by a distance from about 10 cm to about 15 cm. Further, although the head 100 may spin about the imaginary axis 102 at other speeds, in one embodiment the head spins about the imaginary axis at speed from about 2000 rpm to about 10,000 rpm.

During use, the working end 64 of the line 60 frays and breaks. When the line 60 breaks off so the distance from the working end 64 to the imaginary axis 102 becomes shorter than optimal, the user may actuate the motor 82 to turn the roller 72 to advance line 60 from the supply 50. As the other features of the operation of the apparatus 20 are conventional, they will not be described in further detail.

In some embodiments of the present invention, it is envisioned that light may be transmitted through the line 60 to improve an ability of a user to identify where the working end 64 of the line is positioned. It is contemplated that by knowing where the working end 64 of the line 60 is in relation to the shroud 92, less line will be unnecessarily fed out and wasted. In one such embodiment, a light source 150 (FIG. 2) such as a laser is operatively connected to the line 60 in the housing 54 for transmitting light energy to a line adapted to transmit the energy. For example, the line 60 may be optically transparent so it is able to transmit light energy. The light energy is transmitted through the line 60 from the source 150 to the working end 64 of the line. As will be appreciated by those skilled in the art, it is envisioned that the light source 150 may deliver light to the line 60 through a side of the line rather than through an end. As illustrated in FIG. 4, the apparatus 20 may also include a sensor 152 mounted adjacent the working end 64 of the line opposite the end to which the light source 150 is connected for sensing or detecting light transmitted through the line. For example, the sensor 152 may include a lens 154 and fiber optic cable 156 that transmit light received from the working end 64 of the line 60 back to an indicator 158 (FIG. 3) such as a lens on the controls 34. By transmitting light through the line 60 and sensing when light is received by the sensor 152, the proximity of the working end 64 of the line to the sensor can be estimated. In this way, the distance between the working end 64 of the line 60 and the imaginary axis 102 can be estimated. In an alternative embodiment, it is envisioned that proximity can be automatically detected and adjusted by operating the line positioning mechanism. In still other embodiments, the position of the working end 64 of the line 60 may be determined by mechanical or other types of proximity sensors.

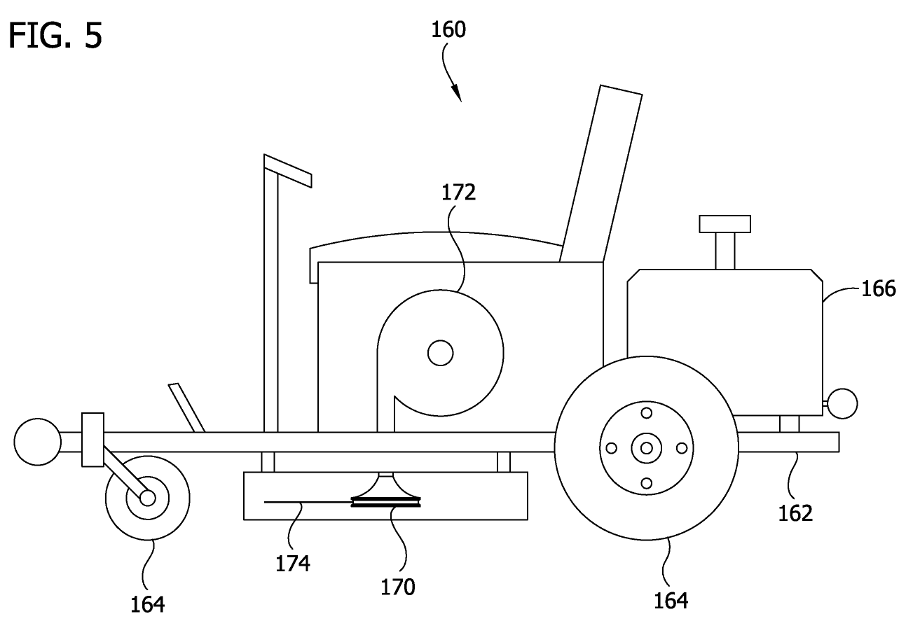

As illustrated in FIG. 5, the advancements provided by the hand held apparatus 20 described above are equally applicable to a riding or push mower, generally designated by 160. The riding version may include an attachment that holds an apparatus 20 similar to that described above or, the riding mower 160 may include a body 162 mounted on wheels 164 for rolling on ground to support the body above the ground. A motor such as a gasoline powered motor 166 is mounted on the body 162. The motor 166 is operatively connected by a generally conventional transmission to a head 170 rotatably mounted on the body 162. The head 170 of this embodiment is generally similar to the previously described head 100. A line supply 172 is mounted on the body 162 for supplying line 174 to the head 170. It is envisioned that a line positioning mechanism (not shown) and a line position sensor (not shown) similar to those shown and described above may also be included in the design. As other features of this embodiment are conventional and well understood by those skilled in the art, they will not be described in further detail.

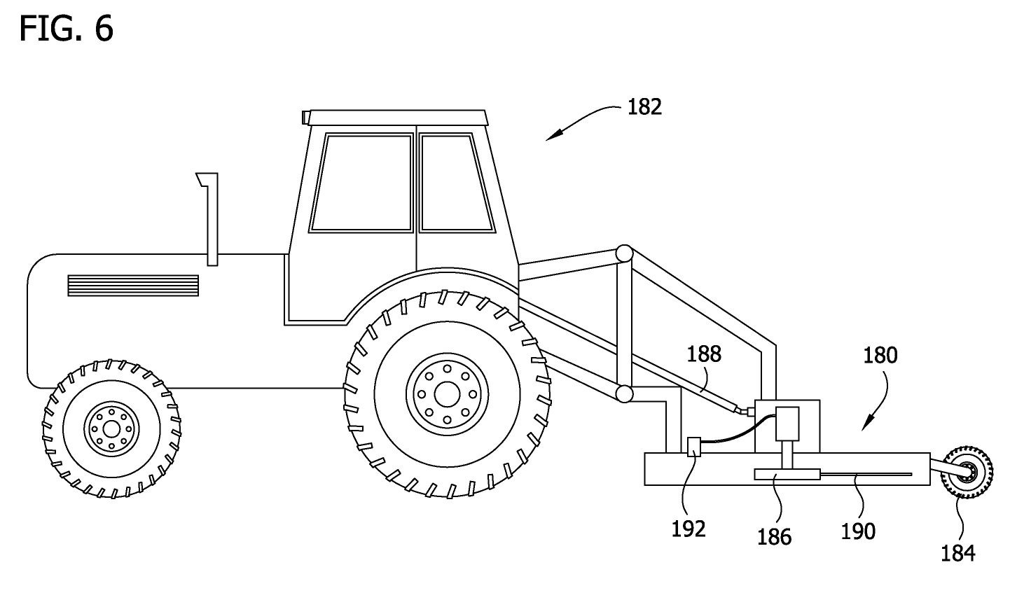

FIG. 6 illustrates a fourth embodiment of the invention comprising apparatus, generally designated by 180, adapted to be pulled behind a tractor, generally designated by 182. As will be appreciated by those skilled in the art, the apparatus 180 may include a wheel 184 or a sled (not shown) for guiding a head 186 above the ground. A conventional drive mechanism such as a rotating shaft 188 powers the apparatus 180 in one embodiment to turn the head 186. A line supply (not shown) is mounted on the apparatus for supplying line 190 to the head 186. A line position sensor 192 operatively connected to a line positioning mechanism (not shown) similar to those described above are included in one embodiment of this design. It is envisioned that the line 190 may comprise a metal cable or chain to enhance an ability of the apparatus 180 to cut brush and thicker vegetation. Other features of this embodiment are conventional and will not be described in further detail.

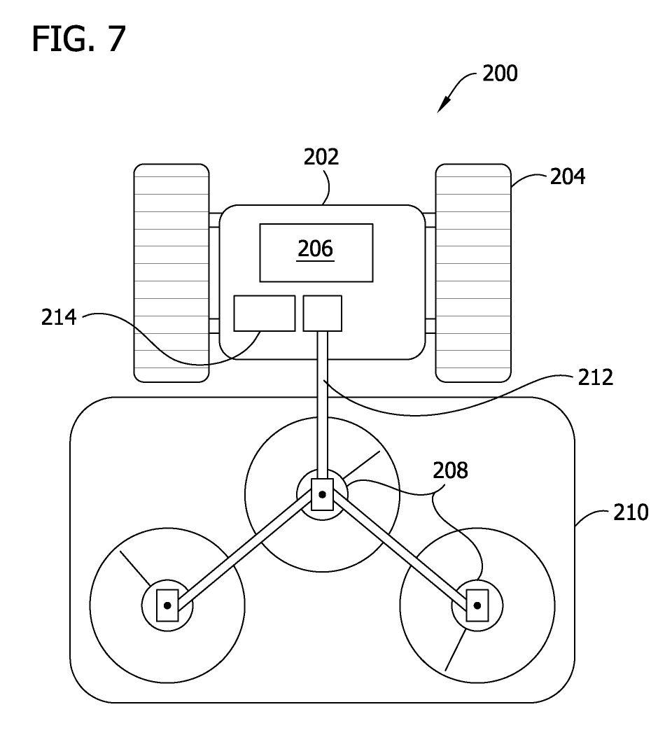

A fifth embodiment of the invention comprising apparatus, generally designated by 200 is illustrated in FIG. 7. The apparatus 200 includes a self-propelled vehicle 202 mounted on tracks 204. The apparatus 200 includes a motor 206 operatively connected to the tracks 204 for guiding one or more heads 208 over the ground. In one embodiment, three heads 208 are gang mounted in a deck 210 suspended from an arm 212 connected to the vehicle 202 for cutting vegetation. The apparatus 200 also includes a remotely operated controller 214 for controlling the apparatus. It is envisioned that the controller 214 may be used to steer the apparatus 200 as well as guide other functions of the apparatus as described above with respect to other embodiments of the present invention. It is further envisioned that the vehicle may include a wheel, a skid or a leg such as a robotic leg in addition to or instead of the track without departing from the scope of the present invention. As other features of this embodiment are conventional, they will not be described in further detail.

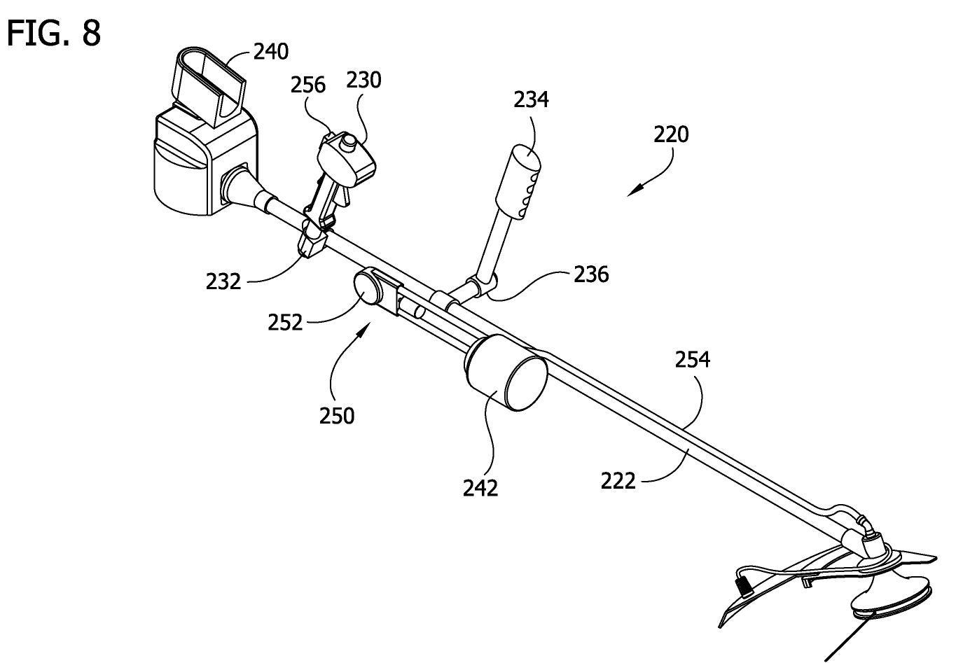

FIG. 8 illustrates another embodiment of the apparatus, generally designated by 220 of the present invention. Because many of the features of the fifth embodiment are identical to those of the first embodiment, they will not be described in detail. Rather, only those features that differ from the first embodiment of the apparatus 20 will be described. As shown in FIG. 8, the apparatus 220 of the fifth embodiment includes a body 222 having a grip 230 extending at an angle above the body. The grip 230 includes a coupling 232 for mounting the grip to the body 222. The apparatus 220 also includes a handle 234 extending laterally from the body 222. The handle 234 also includes a coupling 236 for mounting the handle to the body 222. In one embodiment, the couplings 232, 236 are adjustable to position the grip 230 and the handle 234, respectively, for maximum comfort. For example, the coupling 232 may allow the grip 230 to be moved axially to various positions along the body 222 and pivot laterally and/or pivot fore and aft to position the grip in various angles relative body. The grip 230 may also be rotatable about its longitudinal axis to various rotational angles and moveable vertically to positions spaced at various distances from the body 222. Further, in one embodiment the coupling 232 and grip 230 may be moved independently in all these directions. In one embodiment, the coupling 236 and handle 234 are fully adjustable so the handle can be moved relative to the body 222 similarly to the grip 230. In one embodiment, the apparatus 220 includes a saddle 240 for receiving a forearm of a user. The saddle 240 may also have padding and be adjustable to provide comfort to the user. It is believed that the adjustable grip 230, handle 234 and/or saddle 240 will allow a user to operate the apparatus 220 for longer periods without discomfort. Longer periods of use are envisioned as a result of being able to use the apparatus 220 without disassembling the head to untangle the line or install fresh line.

As also shown in FIG. 8, the apparatus 220 has a supply housing 242 having a different configuration. It is envisioned that the housing 242 may be a point-of-sale container that fastens to the apparatus 220. In some embodiments, the housing 242 includes screw threads or a bayonet mount for attaching the housing to the apparatus. As further illustrated in FIG. 8, the apparatus 220 includes a reconfigured line positioning mechanism, generally designated by 250. The mechanism 250 includes a housing 252 having a roller (not shown) inside. The line wraps around the roller and is directed down a tube 254 as described above. In one embodiment, it is envisioned that a control switch 256 may be positioned on the grip 230 for controlling operation of the line positioning mechanism. As other features of the apparatus 220 of the fifth embodiment are identical to those of the first, they will not be described in further detail.

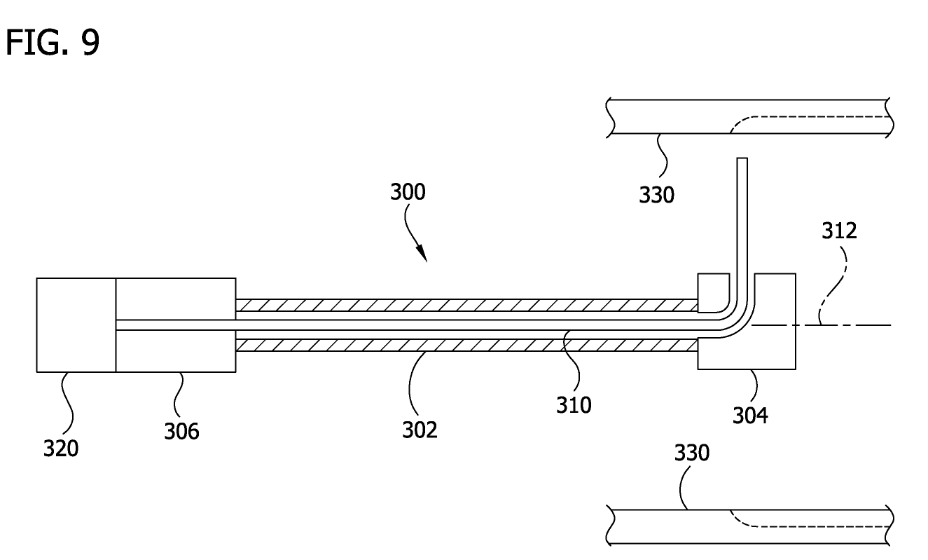

FIGS. 9-11 schematically illustrate various conceptual embodiments that the technology described above enables. For example, FIG. 9 illustrates apparatus of a sixth embodiment of the present invention that is generally designated by 300. The apparatus 300 includes a body 302, a head 304 mounted at one end of the body and a motor 306 mounted at the other end of the body for rotating line 310 about an imaginary axis 312. The apparatus 300 may include an energy source 320 operatively connected to the line 310 for transmitting information from the energy source 320 to an interior surface 330 of an object. For example, it is envisioned that high powered energy could be delivered through the line 310 to cut a portion of the interior surface 330. As will be appreciated by those skilled in the art, the apparatus 300 can cut the interior surface 330 to various depths along its length. Alternatively, the apparatus 300 could mark the interior surface 330 with laser energy. Those skilled in the art will appreciate that a laser apparatus functionally similar to this design may be used to cut vegetation.

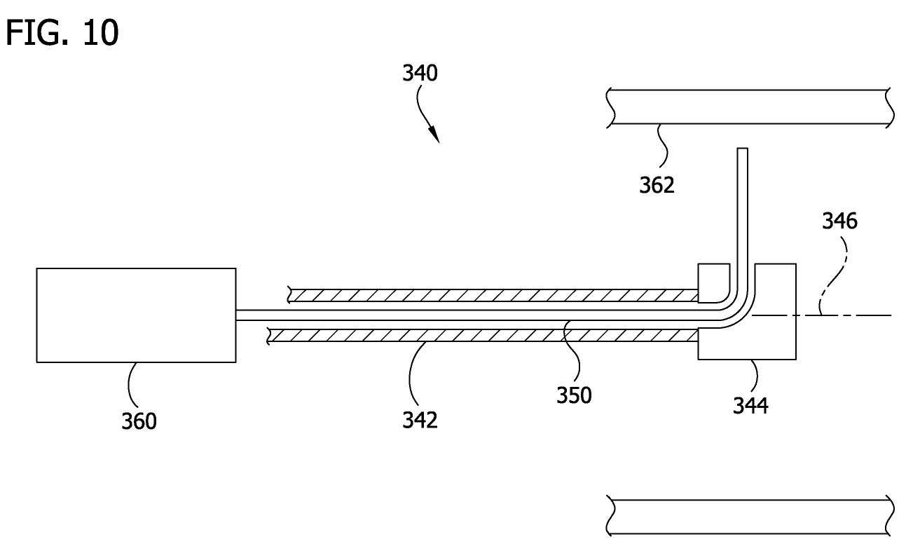

FIG. 10 schematically illustrates apparatus of a seventh embodiment, generally designated by 340. The apparatus 340 includes a body 342 having a head 344 at one end. The head 344 rotates an imaginary axis 346. In this embodiment, line 350 extends through the body 342 to a sensor 360 positioned outside a hollow body 362. The sensor 360 can “read” information, such as laser encrypted code, present on an inside surface 364 of the hollow body 362.

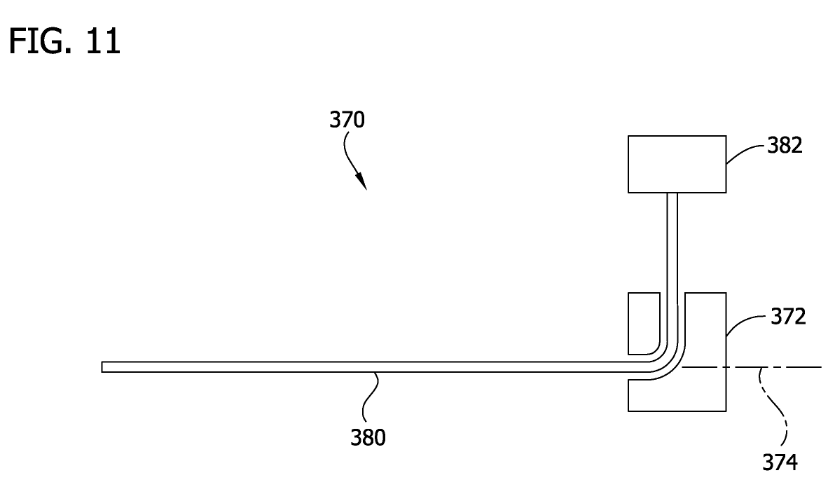

FIG. 11 schematically illustrates apparatus of an eighth embodiment, generally designated by 370. The apparatus includes a head 372 that rotates about an imaginary axis 374. Line 380 extending through the head 372 holds a device 382 such as a cutting head, a laser or an energy source so that the device 382 can be spun about the imaginary axis in response to the head 372 spinning. Those skilled in the art, will appreciate that this apparatus 370 can be used to process the interiors of hollow bodies (not shown)

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that several advantages are achieved by the present invention.

As various changes could be made in the above constructions, products, and methods without departing from the scope of the invention, it is intended that all matter contained in the above description and shown in the accompanying drawings shall be interpreted as illustrative and not in a limiting sense.

1. Apparatus for swinging a flexible line about an imaginary axis comprising:
an elongate body extending along a centerline between a head end at which the imaginary axis is located and a tail end opposite the head end;
a motor mounted remote from the head end of the body having an output; and
a head rotatably mounted on the head end of the body and operatively connected to the motor output for rotation about the imaginary axis in response to operation of the motor, said head having a curved passage extending from an inlet directed generally along the imaginary axis into which the flexible line is feedable to an outlet directed generally lateral to the imaginary axis through which the line is extendable, said passage being sized for passing the line from the inlet to the outlet.

2. Apparatus as set forth in claim 1 further comprising a line positioning mechanism operatively connectable to line to selectively position an end of the line with respect to the outlet of the head.

3. Apparatus as set forth in claim 2 wherein the line positioning mechanism comprises a rotatably mounted roller positioned for engagement with the line for selectively positioning the end of the line with respect to the outlet of the head in response to rotation of the roller.

4. Apparatus as set forth in claim 3 wherein the roller is selectively rotatable in opposite directions for selectively moving the line through the passage in opposite directions.

5. Apparatus as set forth in claim 3 wherein the roller is configured so the line wraps at least partially around the roller when the roller engages the line.

6. Apparatus as set forth in claim 2 further comprising a position sensor mounted on the body adjacent the line, said sensor being operatively connected to at least one of the motor output and line positioning mechanism to alter line movement when the line reaches a predetermined position.

7. Apparatus as set forth in claim 6 wherein said position sensor comprises a switch positioned adjacent the line.

8. Apparatus as set forth in claim 1 further comprising a transmitter operatively connectable to an end of the line for transmitting information to the line.

9. Apparatus as set forth in claim 8 wherein the transmitter comprises an energy source.

10. Apparatus as set forth in claim 9 wherein the energy source generates light energy for transmitting light energy through the line.

11. Apparatus as set forth in claim 9 further comprising a sensor mounted adjacent an end of the line opposite the end to which the energy source is connected for sensing energy transmitted through the line.

12. Apparatus as set forth in claim 11 wherein the energy source generates light energy for transmitting light energy through the line.

13. Apparatus as set forth in claim 8 further comprising a receiver mounted adjacent an end of the line for receiving information transmitted through the line.

14. Apparatus as set forth in claim 1 further comprising a receiver mounted adjacent an end of the line for receiving information transmitted through the line.

15. Apparatus as set forth in claim 1 further comprising a proximity sensor mounted adjacent an end of the line extending from the head for determining a position of the end of the line.

16. Apparatus as set forth in claim 1 further comprising a guide mounted on the head adjacent the output for guiding the line around the head when objects contact the line.

17. Apparatus as set forth in claim 1 further comprising a transmission operatively connected between the motor output and the head for rotating the head about the imaginary axis in response to operation of the motor.

18. Apparatus as set forth in claim 17 wherein:
the output of the motor comprises a rotating output shaft; and
the imaginary axis of the head and output shaft of the motor are angled with respect to each other.

19. Apparatus as set forth in claim 18 further comprising a housing surrounding the transmission having an opening for receiving line therethrough.

20. Apparatus as set forth in claim 1 configured for swinging line adapted for cutting vegetation.

21-80. (canceled)
